(19) United States
(12) Patent Application Publication
(10) Pub. No.: US 2010/0217656 A1
(43) Pub. Date: Aug. 26, 2010

(54) METHOD AND A SYSTEM FOR SUPERVISING THE ACTIVITY OF A USER IN A VIRTUAL WORLD

(75) Inventors: Loïc Bouget, Rennes (FR); Christophe Floutier, Rennes (FR); Guillaume Bataille, Noyal Sur Vilaine (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/706,844

(22) Filed: Feb. 17, 2010

(30) Foreign Application Priority Data
Feb. 20, 2009 (FR) 09 51120

(51) Int. Cl. G06F 17/00; G06T 15/00; G06Q 30/00

(52) U.S. Cl. 705/14.4; 345/419

(57) ABSTRACT

A method of supervising the activity of a user in a virtual world comprising the steps of: (1) detecting at least one item of collision information between an observation line associated with the user and at least one first virtual object within the virtual world; and (2) determining at least one item of interaction information between the user and the first object on the basis of the collision information.

### CROSS-REFERENCE TO RELATED PATENT APPLICATION

This application claims the benefit of French Patent Application No. 09 51120, filed on Feb. 20, 2009, in the French Institute of Industrial Property, the entire contents of which is incorporated herein by reference.

### FIELD OF THE INVENTION

The present invention relates to a technique of tracking and analyzing the behavior and the activity of a user acting within a virtual reality environment, also commonly referred to as a virtual world.

The invention seeks to obtain effective management concerning tracking a user's journey in the virtual world, and collecting visibility information relating to virtual objects, for example and in non-limiting manner, objects of the advertising media type, which are incorporated in a virtual world. The invention also seeks to process interaction information concerning interaction between a user and such virtual objects.

### BACKGROUND OF THE INVENTION

A large amount of work has been undertaken in the field of virtual reality in order to improve the quality of virtual worlds, and the quality of the interactions of a user with one or more avatars representing the user within the such virtual worlds, or indeed to encourage natural and intuitive interactions between avatars. Nevertheless, the inventors have noted a lack of any technical solution suitable for managing statistics of interactions with virtual objects present in virtual worlds, as a function of the behavior of a user, or indeed as a function of the behavior of a plurality of users acting within the same virtual world. Nevertheless, such statistics could be of considerable interest in the context of advertising applications.

### SUMMARY OF THE INVENTION

In this context, the invention consists in providing an effective solution to the problem of supervising the behavior of a user in a virtual three-dimensional (3D) world, particularly but not exclusively supervising the user's journey within the virtual world, interactions with various objects included in the virtual world, in particular advertising panels or shop windows that are present within the virtual world, and the visibility of advertising objects for the user on moving within the 3D world.

The invention also seeks to provide a technique that is simple and effective that enables the 3D virtual world to be adapted or personalized in deferred or real time, taking account of a result of supervising the behavior of one or more users acting within a 3D virtual world.

In this respect, the invention provides a method of supervising the behavior of a user in a virtual world. According to the invention, such a method advantageously comprises the following steps:

detecting at least one item of collision information between an observation line associated with said user and at least one first virtual object within said virtual world; and

determining at least one item of interaction information between the user and said first object on the basis of said collision information.

As the user journeys within a virtual world, the detected collision information serves to indicate whether an imaginary line representative of a user's gaze, referred to as an observation line, has intersected at a least a portion of a predetermined virtual object, such as for example, and in non-limiting manner, an advertising panel.

Once said collision information between the line of gaze of the user moving within said virtual world and an object included therein has been detected, the step of determining an item of interaction information serves to anticipate the type of the interaction that takes place between the user and said object.

It is possible to distinguish between the user's line of gaze merely passing over the surface of an object included in the virtual world, and the user's line of gaze pausing for a long time on said object, where such a pause may be interpreted as being synonymous with the user marking an interest in said object.

Similarly, it is possible to distinguish between the observation point coming closer to said object, which may be interpreted as a mark of interest, in comparison with the observation point moving away from said object, which may be interpreted as being a mark of the user being uninterested in said object.

In a preferred implementation of the invention, the method of the invention includes an additional step of forwarding said interaction information to an interaction monitoring entity in order to calculate at least one interaction measurement specific to said first virtual object.

Once the interaction information between the user and a given object contained within the virtual world in which the user is traveling has been determined, in said step of determining at least one item of interaction information, the information is forwarded to an interaction monitoring entity in order to calculate at least one interaction measurement specific to said virtual object.

The advantage of the invention in a context of evaluating the visibility of a given virtual object within a 3D virtual world and of evaluating a measured level of interaction between the user and said object can thus readily be understood, particularly when the object is of the virtual advertising panel type displaying advertising information belonging to the real world, or a virtual shop window reproducing a shop window that is known in the real world.

The method of the invention thus advantageously enables the behavior of a user acting within a 3D virtual world to be supervised in dynamic and effective manner so as to be able to deduce therefrom improvements for said world in terms of the layout of its various constituent virtual components, of personalizing it for users having identified interest types, etc., or merely for providing audience measurements relating to advertisements or more generally to information made available by display panels or by any other technique within all or part of said virtual world.

Such a method also makes it possible to collect, for a monitoring entity, interaction information of all the following types:

journey of a user within said 3D virtual world;

interaction of the user with any type of advertising medium present in the 3D world (advertising panels, professional shop windows, etc.); and

level of visibility of objects constituting advertising and/or information media, as the user journeys within said virtual world—did the user see the advertising media, from how far away, etc.?

These various items of interaction information may subsequently be interpreted by statistical interpretation methods, audience measurements, or indeed by any other interpretation method.

In a preferred implementation of the invention, the method of the invention includes a step of adapting said first virtual object as a function of at least one interaction measurement calculated for said first virtual object.

Such an approach turns out to be particularly advantageous in that it enables the first virtual object to be adapted or indeed personalized as a function of the measured level of interaction as determined for one user and said first object. By way of illustrative and non-limiting example of the invention, such an adaptation might consist in proposing a second personalized advertisement on a virtual object of the advertising panel type once the user has given a long look at a first advertisement that was initially available on the advertising panel, or indeed displaying additional information to said user.

In a variant implementation of the method of the invention, the method includes a step of adapting at least one second virtual object, said step taking account of at least one interaction measurement calculated for said first virtual object and at least one predicted movement of said user within a neighborhood of said second object.

Such a variant implementation of the method of the invention advantageously enables extended personalized adaptation to be applied to all or some of the objects contained within said virtual world as a user moves or journeys within the virtual world, and while taking account of an interaction measurement calculated for said user and relative to said first object.

It is naturally possible to extend this variant implementation of the method of the invention to adapting the virtual world, or at least to adapting only certain constituent scenes thereof. Such scenes may be defined as zones of said virtual world that form a neighborhood of a location around said user. Such combined or respective adaptations may also advantageously take account of a plurality of interaction measurements calculated by said measurement entity concerning interaction levels relating to a plurality of users.

Such an approach amounts to enabling all or part of a virtual world to be adapted dynamically as a function of audience measurements or of interests specific to the users of the virtual world. This can be particularly advantageous in terms of updating and/or adapting any advertising or information media voluntarily made available within the virtual world, with this being done as a function of interest criteria as measured or detected and relating to the users of said virtual world.

In order to avoid pointlessly consuming hardware and/or software resources, the optionally dynamic adaptation of scenes or objects constituting the virtual world should be done as a function of predicted movements of said user within a vicinity of said second object or the scene that is to be dynamically adapted. Such a technical approach is found to be particularly pertinent and effective since firstly it serves to save on hardware and software resources, the virtual world being adapted at any given instant only for that portion of said environment that corresponds to a zone in which the user is acting at that instant, and secondly because it enables the adaptation of said virtual environment to be limited to portions of said environment that are actually visible to the user as the user travels within the virtual environment.

The ray tracing technique is a rendering technique that is applied to image synthesis, and normally consists in simulating the reverse of the path of light from a point of a scene included within a virtual environment to a point that is representative of an eye of a user.

Thus, preferably, said detection step comprises a ray tracing step between an observation point representative of a gaze position specific to said user and at least one object situated within a angle of vision defined from said observation point, so as to obtain at least one item of information representative of a degree of visibility of said at least one object for said user.

In the context of the invention, this ray tracing technique is advantageously implemented in a manner that is inverse to the way it is normally used as known to the person skilled in the art, in order to obtain visibility information representative of whether an object contained in a scene of a virtual environment is visible in part, in full, from behind, etc., with the ray then being traced from an observation point representative of a gaze position of a user towards an object contained in said scene and situated within an angle from said observation point and defining the field of view of the user. This approach serves advantageously to determine easily whether an object of the advertising panel type is indeed visible, in full or in part, to the user in the current field of view. As a function of this information concerning the visibility of an object contained within a virtual environment under consideration as determined by this particular application of the ray tracing technique, it is subsequently possible, in optimum manner, to reposition the panel or the object within said virtual environment so as to give it greater or better visibility for users, should that be necessary.

Advantageously, the supervision method of the invention includes a step of determining a level of visibility obtained by comparing said information representative of a degree of visibility with at least one predetermined visibility criterion belonging to the group comprising:

a threshold for the apparent surface area of said object;

a threshold for the distance of said object from said observation point; and

a location of the center of said object within said angle of vision.

In an advantageous implementation of the invention, said object is of the virtual panel type for receiving at least one advertisement, and said level of visibility is forwarded to said interaction information measurement entity during said forwarding step, so as to calculate at least one audience measurement value for said advertisement within said virtual world.

Advantageously, said interaction information is of the type forming part of the group comprising:

a duration of observation of said first object;

said representative observation point approaching said first object;

said representative observation point moving away from said first object; and

said observation point turning away from said first object.

In a preferred implementation of the invention, said detection step is performed dynamically, at regular time intervals, during the movement of said user within said virtual world.

Such an approach serves firstly to evaluate different items of interaction information over a short period of time so as to propose or anticipate updating of all or part of the virtual environment practically in real time, thereby increasing the level of attractiveness for the user. Furthermore, since the updating of said virtual environment is not necessarily identical for all users, the time intervals defined in the context of managing updates specific to each user can be defined so as to avoid simultaneous updates, thereby economizing the hardware and software resources on which the virtual world is based, while also adapting the advertising content that is selected as a function of the behavior of a user.

Preferably, said dynamic collision detection step takes account of a neighborhood of said user, said neighborhood being formed by a zone defined around said observation point and having at least one point belonging to the outline of said zone that is situated at a predetermined distance from said observation point.

Such a neighborhood may for example be in the form of a disk with a radius of length that has previously been set from said observation point.

The invention also provides a system for monitoring/supervising the activity of a user in a virtual environment.

The system preferably comprises:

means for dynamically detecting at least one item of collision information between an observation point of the user, a scene forming part of said virtual environment, and at least one object constituting said scene;

means for determining at least one item of interaction information between the user and said object on the basis of said collision information; and

means for forwarding said interaction information to an entity for measuring interaction information in order to calculate at least one measurement of interaction with said object that is specific to said user.

Advantageously, the invention also provides a computer program product that is downloadable from a communications network and/or stored on a medium that is readable by computer and/or executable by a microprocessor, such a program including program code instructions for executing a supervision method as specified above on being executed by a computer.

It is naturally possible, without any limit, to envisage any other combination of the above-mentioned characteristics specific to the method of supervising the behavior of a user in a virtual environment, as described above.

### BRIEF DESCRIPTION OF THE DRAWINGS

The technical advantages and characteristics of the present invention appear better from the following description made by way of non-limiting indication and with reference to the accompanying drawings, in which:

FIG. 1 shows the general principle of determining collision information relative to a set of advertising panels present within a scene of a virtual environment; and

FIG. 2 summarizes the major steps of a method of supervising the activity of a user in a virtual environment of the invention.

### DETAILED DESCRIPTION

The principle of supervising the activity of a user within a virtual world or environment relies on determining visibility information by executing collision detection routines between an observation point representative of a viewing position of a user in the virtual world and 3D objects constituting said world and/or present therein.

These routines serve to define the concept of local 3D scenes around an observer. They also implement ray-tracing functions in a method of application that is the inverse of that normally taken into consideration in the field of synthesizing images, so as to detect whether an object contained in a scene is or is not visible from a given observation point.

Standardized AFX algorithms, such as PB-Tree and wavelets, serve to guarantee that, at any given instant, the local scenes needed for 3D rendering are minimized in terms of complexity and graphics primitives.

As mentioned above, the collision system maintains a local scene around the observer. This mini-scene contains a geometrical description of all of the objects near to the observer (these objects are referred to herein as “geometrical primitives”). At present, the only geometrical primitives that are managed by the rendering engine of the virtual environment (also referred to as the “player”) are 2.5D buildings, and geometrical primitives for terrain or indeed point objects representing street furniture, advertising panels, etc.

A ray tracer having as its origin the position of the observer's eye and as its destination an arbitrary 3D point P serves to determine whether that point is hidden by a geometrical primitive. That is the system that is used for detecting the visibility of advertising media.

For performance reasons, only one ray trace is used for each panel, the selected destination point being the center of a virtual object, e.g. and in non-limiting manner, the center of an advertising panel contained in a scene defined in the neighborhood of the user's observation point.

In the same manner as a city manager updating geometrical primitives corresponding to buildings in the local scene, an advertising manager can perform an updating and/or adapting function in respect of one or more panels present in a local scene, i.e. a scene that is situated directly in the neighborhood of a user's own observation point.

The collision information as detected in this way is necessary since some advertising media may hide other advertising media.

It should be observed that the frequency of such updating need not be as high as the rendering frequency (five updates per second suffice).

The other role of the advertising manager is to collect the visibility information for each panel in order to deliver it to a metering third party.

The visibility test for an advertising medium is performed by means of a list of processes that are in order of increasing cost, so as to eliminate as soon as possible those panels that are not visible.

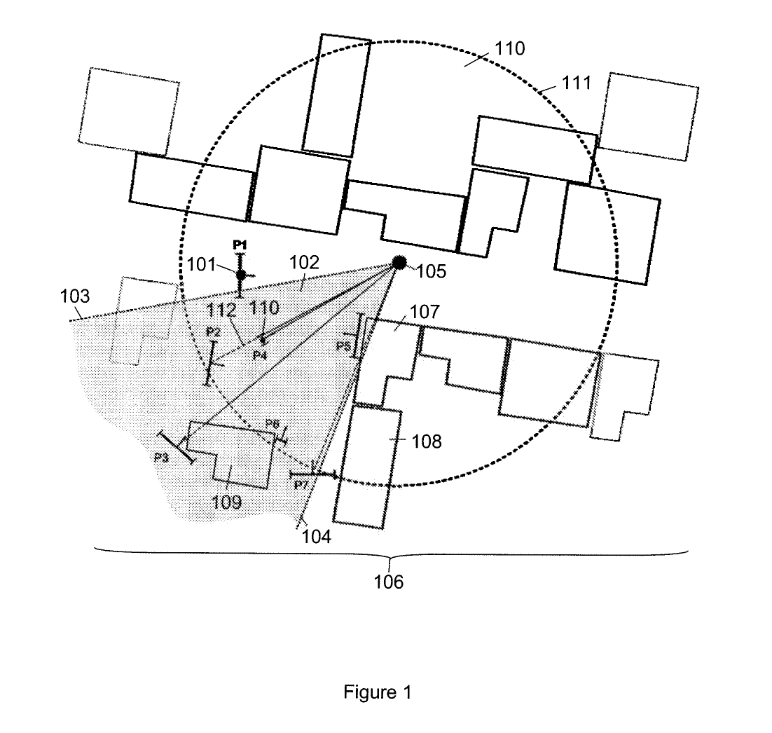

FIG. 1 shows the various circumstances that can arise. Amongst the seven advertising media P1 to P7 contained in the local scene, only the panel P4 is considered as being visible in accordance with the visibility criteria in use.

The illustrative and non-limiting list of applied processes is as follows, in increasing order of load on the central processor unit (CPU):

if the face of the panel that is exposed to the observer is its rear face, then the medium cannot be visible. This applies to panel P5 in FIG. 1;

if the maximum apparent area of the medium is less than a given threshold, then the medium is considered as not being visible. This criterion represents the fact that the medium is either too far away or that it is at a viewing angle that is too close to grazing. This filtering serves to eliminate panel P6 in FIG. 1;

if the center 101 of the medium P1 is not in the field 102 of visibility for the user as defined by the angle formed between the straight lines 103 and 104 from the observation point 105 characteristic of a location for the gaze of the user in the virtual environment 106, then the medium P1 is considered as not being visible (an acceptable approximation); and finally

if all of the above tests have been unable to determine that a medium is not visible, then the fine test is performed, i.e. a ray is traced making it possible to determine whether the medium is hidden by some other geometrical feature (107, 108, 109), e.g. buildings, terrain, other panels, etc. In FIG. 1, the media P2, P3, and P7 are considered as being not visible in application of this criterion. P2 is masked at least in part by the panel P4.

Together, these criteria serve to determine a binary visibility value for each medium, characteristic of interaction information.

It is possible to provide a better approximation by calculating visibility in the form of a percentage. Under such circumstances, a plurality of reference points are used for each medium instead of one.

Once said collision information has been detected between the line of gaze of the user as taken by the user into said virtual environment, and an object constituting said environment, then the step of determining interaction information serves to anticipate the type of the interaction detected between the user and said object. It is thus possible to distinguish between mere passing by without the user's line of gaze stopping on the surface of an object present within the virtual environment, and a prolonged pause of the user's line of gaze on said object, such a pause being suitable for being interpreted as a synonym for the user showing interest in said object. Similarly, it is possible to distinguish between the observation point being moved closer to said object, which can be interpreted as a mark of interest, as compared with the observation point being moved away from said object, which can be interpreted as a mark of a user being uninterested in said object.

Once the interaction information between the user and a given object contained within the virtual environment through which the user is traveling has been determined, this information is transmitted to an interaction monitoring entity in order to calculate at least one interaction measurement specific to said virtual object.

The advantage of the invention in a context of evaluating the visibility of a given virtual object within a 3D virtual world or environment and of evaluating a measured level of interaction between the user and said object can thus readily be understood, particularly when the object is of the virtual advertising panel type delivering advertising information forming part of the real world, or a virtual shop window reproducing a shop window that is known in the real world.

The method of the invention thus advantageously makes it possible to perform dynamic and effective supervision of the behavior of a user moving within a 3D virtual world or environment for the purpose of being able to deduce improvements for said world in terms of a layout for its various constituent virtual components, in terms of personalizing it to users having identified types of interests, etc., or merely to performing audience measurements relating to advertising or more generally to information disseminated by billboards or any other technique within all or part of said virtual world.

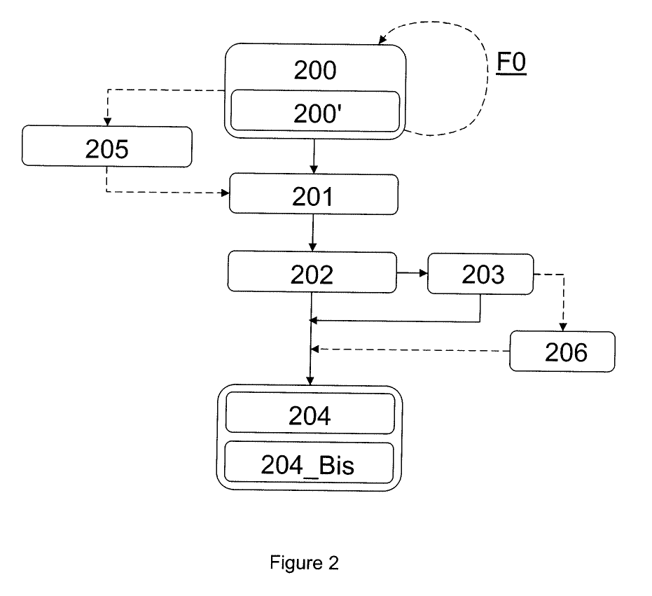

The major steps in the method of supervising the activity of a user within a virtual environment are summarized with reference to FIG. 2 in association with FIG. 1:

detecting 200 at least one item of collision information between a line 112 of observation associated with said user and at least one first virtual object (P2) within said virtual world 106. Such a detection step 200 implements a step 200′ of tracing a ray from an observation point 105 representative of a gaze position specific to said user and at least one object P4 situated within a defined viewing angle 102 starting from said observation point 105 and lying between the lines 103 and 104, so as to obtain at least one item of visibility information for said user concerning said at least one object P2;

determining 201 at least one item of interaction information between the user and said first object P2 on the basis of said collision information; and

transmitting 202 said interaction information to an interaction monitoring entity in order to calculate 203 at least one interaction measurement specific to said first virtual object P4.

In two possible variant implementations of the invention, the method includes a step 204 of adapting said first virtual object P2 as a function of said calculated interaction measurement, or a step 204_Bis of adapting at least one second virtual object P4, said step 204_Bis then taking account of at least one calculated interaction measurement for said first object P2 and at least one predicted item of information concerning the movement of said user within a neighborhood of said object P4.

The method of the invention also includes a step 205 of determining a level of visibility obtained by comparing said information representative of a degree of visibility with at least one predetermined visibility criterion belonging to the group comprising:

a threshold for the apparent surface area of said object;

a threshold for the distance of said object from said observation point; and

the location of the center 110 of said object P2 within said angle 102 of vision.

In the invention, with said object P2 being of the virtual panel type suitable for receiving at least one advertisement, said visibility level is forwarded to said interaction information measurement entity during said transmission step 202 in order to calculate 206 at least one audience measurement value for said advertisement within said virtual environment 106.

In one possible implementation of the invention, said interaction information is of the type forming part of the group comprising:

a duration of observation of said first object;

an observation point representative of the user's gaze approaching said first object;

said representative observation point moving away from said first object; and

said observation point turning away from said first object.

Said detection step 200, which may be dynamic, is performed (arrow F0, FIG. 2) at regular time intervals, during the movement of said user within said virtual environment, by means of a step 200′ of tracing a ray between said observation point and said at least one first virtual object P4.

Account is also taken of the neighborhood 100 of said user, said neighborhood 100 being made up of a defined zone around said observation point 105, with at least one point forming part of the outline of said zone 100 being situated at a predetermined distance from said observation point 105.

The technical solution proposed thus enables effective supervision to be performed of the path followed by the user in a 3D environment, and more generally of the user's activities therein. It also serves to collect visibility information about advertising media incorporated in the 3D environment and to collect user interactions with the advertising media.

What is claimed is:

1. A method of supervising the activity of a user in a virtual world, the method comprising the following steps:
detecting at least one item of collision information between an observation line associated with said user and at least one first virtual object within said virtual world; and
determining at least one item of interaction information between the user and said first object on the basis of said collision information.

2. The method according to claim 1, further comprising a step of forwarding said interaction information to an interaction monitoring entity in order to calculate at least one interaction measurement specific to said first virtual object.

3. The method according to claim 1, further comprising a step of adapting said first virtual object as a function of at least one interaction measurement calculated for said first virtual object.

4. The method according to claim 1, further comprising a step of adapting at least one second virtual object, said step taking account of at least one interaction measurement calculated for said first virtual object and of at least one predicted movement of said user within a neighborhood of said second object.

5. The method according to claim 1, wherein said detection step comprises a step of tracing a ray between an observation point representative of a gaze position specific to said user and at least one object situated within an angle of vision defined from said observation point, so as to obtain at least one item of information representative of a degree of visibility of said at least one object by said user.

6. The method according to claim 5, further comprising a step of determining a level of visibility obtained by comparing said information representative of a degree of visibility with at least one predetermined visibility criterion belonging to the group comprising:
a threshold for the apparent surface area of said object;
a threshold for the distance of said object from said observation point; and
a location of the center of said object within said angle of vision.

7. The method according to claim 6, wherein said object is of the virtual panel type for receiving at least one advertisement, and said level of visibility is forwarded to an interaction information measurement entity during said forwarding step, so as to calculate at least one audience measurement value for said advertisement within said virtual world.

8. The method according to claim 5, wherein said interaction information is of the type forming part of the group comprising:
a duration of observation of said first object;
said representative observation point approaching said first object;
said representative observation point moving away from said first object; and
said observation point turning away from said first object.

9. The method according to claim 1, wherein said detection step is performed dynamically, at regular time intervals, during the movement of said user within said virtual world.

10. The method according to claim 5, wherein said detection step takes account of a neighborhood of said user, said neighborhood being formed by a zone defined around said observation point and having at least one point belonging to the outline of said zone that is situated at a predetermined distance from said observation point.

11. A system for supervising the activity of a user in a virtual world, the system comprising:
means for detecting at least one item of collision information between an observation line associated with said user and at least one first virtual object within said virtual world; and
means for determining at least one item of interaction information between the user and said first object on the basis of said collision information.

12. The system according to claim 11, further comprising means for forwarding said interaction information to an interaction monitoring entity in order to calculate at least one interaction measurement specific to said first object.

13. A computer program product downloadable from a communications network, wherein the product comprises program code instructions for executing a method of supervising the activity of a user in a virtual world according to claim 1, when executed on a computer.

14. A computer program product stored on a computer-readable medium, wherein the product comprises program code instructions for executing a method of supervising the activity of a user in a virtual world according to claim 1, when executed on a computer.

15. A computer program product executable by a microprocessor, wherein the product comprises program code instructions for executing a method of supervising the activity of a user in a virtual world according to claim 1, when executed on a computer.
